(19) United States
(12) Patent Application Publication
(10) Pub. No.: US 2013/0266871 A1
(43) Pub. Date: Oct. 10, 2013

(54) ELECTRICAL CONDUCTOR FOR ELECTROCHEMICAL CELLS

(71) Applicants: Thomas Berger, Pfinztal (DE); Karsten Pinkwart, Pfinztal (DE); Jens Tubke, Waldbronn (DE)

(72) Inventors: Thomas Berger, Pfinztal (DE); Karsten Pinkwart, Pfinztal (DE); Jens Tubke, Waldbronn (DE)

(21) Appl. No.: 13/820,631

(22) PCT Filed: Sep. 8, 2011
(86) PCT No.: PCT/EP11/65558

§ 371 Date: Jun. 26, 2013

(30) Foreign Application Priority Data
Sep. 10, 2010 (DE) 102010040574.4

(51) Int. Cl. H01M 4/66

(52) U.S. Cl. CPC H01M 4/661
USPC 429/233

(57) ABSTRACT

Use of an electrical foil conductor in an electrochemical cell, wherein the foil comprises a substrate which is coated with an electrical conductor and the substrate has a lower mass per unit area than the conductor.

The present invention relates to a novel use of conductive multilayer foils as well as electrochemical cells comprising said multilayer foils.

In secondary and primary electrochemical cells various materials are used as electrical conductor. Requirements, which should be met by the electrical conductor, inter alia, are a very good electrical conductivity, mechanical and thermal stability as well as the possibility of a permanent mechanically and chemically stable coating with the electroactive material. Furthermore, for technical processing reasons, resulting from conventional coating methods such as knife coating, paste coating or laminating, corresponding materials for the electrical conductor and corresponding layer thicknesses of the electrical conductor have to be selected. Thus, in case of the anode for lithium ion cells the electrical conductors are preferably made of copper. The disadvantage of copper electrical conductors is that due to its high density (8.92 g/cm³) the total weight of the electrochemical cell is relatively high and thus a reduction of energy density for the entire electrochemical cell occurs.

Therefore, one goal in the development of lithium ion cells is inter alia to increase the energy density through novel cathode materials having a high oxidation potential. As a result, for example, specific requirements are to be met by the electrical conductor of the cathode with regard to the electrochemical stability in the electrochemical cell. In many cases only the refractory metals have a sufficient electrochemical stability.

For anode materials having a reduction potential close to the electrochemical deposition of lithium (such as, for example, the conventionally used graphite anode) electrical conductor materials are to be used which do not form alloys with lithium since the potential of the alloy formation for light metals, such as for example, aluminum, is more positive than the desired intercalation compound of lithium and graphite. A use of such materials leads through the lithium alloy formation to a mechanical destruction of the electrical conductor. Accordingly, a frequently used metal for the anode of lithium ion cells is copper fulfilling the chemical and mechanical requirements. Due to its high density, the copper is preferably processed as foil as thin as possible in order to keep the energy density of the electrochemical cell high. However, the manufacturing and processing methods and the thus resulting mechanical resistances for copper conductors lead to practical limitations. A foil thickness of less than 8 μm is not advisable for technical reasons.

Therefore, the aim of the invention is to develop an electrical conductor, in particular an electrical conductor for the anode of electrochemical cells such as lithium ion cells, which has a good electrical conductivity at low density and is thermally and mechanically stable and thus makes a positive contribution for increasing of the energy density of an electrochemical cell.

The present invention is based on the finding that the electrical conductor must consist of a stable but light weight substrate material which is coated with a good electrical conductor.

Therefore, the present invention is directed to the use of a foil (F) as electrical conductor in an electrochemical cell (Z), characterized in that the foil (F) comprises a substrate (T) which is coated with an electrical conductor (L) and the substrate (T) has a lower specific density (mg/cm³) than the conductor (L).

The electrochemical cell (Z) can be a primary or secondary cell. Preferably, it is a secondary cell. Primary cells refer to electrochemical cells which are not rechargeable, whereas secondary cells are rechargeable.

In one specific embodiment, the electrochemical cell (Z) is a lithium ion cell, in particular a secondary lithium ion cell. Lithium ion cells are generally known. Amongst others, it is referred to “Chemische Technik, Volume 6b, Winnacker, et all., 5^{th} edition, 2006”.

A conductor (L) in the meaning of the present application is a conductor which is able to transport electrical current.

A foil (F) in the meaning of the present invention is a thin, laminar and flexible electrical conductor. Preferably, the foil (F) has an electrical conductivity of at least 7.5×10⁶ S/m, more preferably of at least 25.0×10⁶ S/m, such as of at least 38.0×10⁶ S/m. In particular, these electrical conductivities apply to foils (F) for the use as anode conductor.

The mass per unit area of the foil (F) is low compared to conventional electrical conductors, particularly compared to conductors for the anode of electrochemical cells such as lithium ion cells. Accordingly, the foil (F) preferably has a mass per unit area of not more than 7.0 mg/cm², more preferably of not more than 5.0 mg/cm², particularly from 2.5 to 4.2 mg/cm².

In order to keep the overall construction of the electrochemical cell, such as lithium ion cell, relatively small, the thickness of the foil (F) should not exceed 20.0 μm. Particularly favourable results are obtained with foils (F) having a thickness of not more than 15.0 μm, particularly with foils (F) having a thickness in the range from 10.0 to 14.0 μm, such as from 11.5 to 13.5 μm.

The ratio of layer thickness [(L)/(T) in μm] in the foil (F) between conductor (L) and substrate (T) is preferably from 0.05/12.00 to 1.00/12.00, particularly between 0.09/12.00 and 0.50/12.00.

In particular, the foil (F) consists of the substrate (T) and the conductor (L).

As mentioned above, the foil (F) comprises a substrate (T). Said substrate (T) ensures the mechanical resistance at low density. Accordingly, the substrate (T) is characterized in that it has a lower specific density (mg/cm³) than the conductor (L).

In principle, there are no limitations for the substrate (T) as long as it can be coated with the conductor (L). Furthermore, the substrate (T) can be electrically conductive, but does not have to be. In particular, in case of electrochemical cells having a high specific capacity, low voltage losses at high current densities and a good thermal conductivity of the substrate material are required, in order to prevent an overheating of the interior of the cell by the resulting heat loss. For this case, light metals having high specific heat and current conductivity, such as aluminum, are advantageous as substrate (T) compared to other substrate materials.

It is desired that the substrate (T) has a mass per unit area of not more than 4.5 mg/cm², more preferably of not more than 2.7 mg/cm², particularly of not more than 1.7 mg/cm². Preferred ranges for the mass per unit area are from 1.4 to 4.5 mg/cm².

Like the foil (F), also the substrate (T) should not exceed a defined thickness. Accordingly, it is preferred that the substrate (T) has a thickness of not more than 14.0 μm, more preferably of not more than 13.0 μm. Preferably, the thickness is in the range from 10.0 to 14.0 μm, such as from 11.0 to 13.0 μm.

Polymers, inorganic materials, alloys and metals as well as composite materials therefrom such as, for example, fiber-reinforced plastic foils, have especially proved their worth. Among them, polymers and metals are preferably to be mentioned. In one preferred embodiment, the substrate (T) is a metal.

If the substrate (T) is a polymer, it is selected from the group of thermoplastics. They can be also fiber- or fabric-reinforced.

If a metal is used as substrate (T), it is selected from the group of light metals having a specific density of <5 g/cm³.

In one especially preferred embodiment, the substrate (T) is aluminum. For example, a 12 μm substrate (T) of aluminum has a mass per unit area that is comparable to a 3.6 μm thick copper foil. However, copper foils of such thickness are unsuitable as conductor in electrochemical cells due to a lack of mechanical stability and processability.

As the substrate (T) ensures the necessary mechanical strength, the conductor (L) can be applied thin. Accordingly, the substrate (T) which has a higher specific density than the substrate (T) does not contribute to the total weight of the electrochemical cell to the extent such that its influence on the total energy density of the electrochemical cell is low.

The mass per unit area of the conductor (L) is predominantly in the range of from 0.5 to 6.0 mg/cm², preferably in the range of from 0.7 to 4.0 mg/cm², like in the range of from 1.0 to 2.0 mg/cm².

The thickness of the conductor (L) should not be more than 0.5 μm, particularly not more than 0.4 μm. In one embodiment, the thickness is from 0.1 to 0.3 μm.

The conductor (L) preferably has an electrical conductivity of at least 30.0×10⁶ S/m, more preferably of at least 50.0×10⁶ S/m, such as of at least 55.0×10⁶ S/m.

It is further preferred that the conductor (L) for anode conductors is of a material which does not form an alloy with lithium. Accordingly, the conductor is preferably selected from the group consisting of Ti, Zr, V, Nb, Ta, Cr, Mo, W, Mn, Fe, Co, Ni, Cu and Ag.

In one especially preferred embodiment, the conductor (L) is copper.

Applying of the conductor (L) on the substrate (T) can be obtained by chemical or physical processes. In particular, galvanic processes, sputter or CVD processes are conceivable. In case of a copper conductor on an aluminum substrate the galvanic deposition from an aqueous electrolyte solution (galvanic coating) is conceivable.

The term “coat” or “coating” in the meaning of the present invention illustrate that the conductor (L) entirely covers the surface of the substrate (T).

The present invention relates not only to the use of the foil (F) in electrochemical cells, such as lithium ion cells, as electrical conductor (L), especially as electrical conductor for the anode, but also to electrochemical cells, such as lithium ion cells, which comprise the foil (F) of the present invention as the conductor (L), especially as conductor for the anode.

In the following, the invention is further described by examples.

### EXAMPLES

In a lithium ion cell with graphite anode on a 8 μm thick copper foil as electrical conductor, the copper foil has a mass per unit area of 7.14 mg/cm². 8 μm is the lowest material thickness for electrolytically produced copper foils at present, with which graphite anodes for Li-ion-cells can be produced on an industrial scale. The tensile strength of the pure copper is about 200 N/mm². Thus, under ideal conditions a tensile stress of 16 N on a 10 mm wide foil strip would lead to a fracture of the foil. The electrical resistance of a 1 m long and 10 mm wide foil strip is about 0.2 Ohm.

However, an aluminum foil having a thickness of 12 μm only has a mass per unit area of 3.24 mg/cm², but has not the required chemical stability as it already comes to the formation of LiAl alloys at a potential of about 300 mV vs. Li/Li⁺ resulting in a mechanical destruction of the foil during loading of the Li-ion-cell. Pure aluminum has compared to copper a substantially lower tensile strength of about 50 N/mm². Thus, a 10 mm wide and 12 μm thick aluminum foil has a maximum of tensile load of about 6N until breakage of the foil. This tensile strength is, however, still sufficient for the processing into electrochemical cells for Li-ion-cells. Cathodes for Li-ion-cells are already prepared on an industrial scale on such thin aluminum foils. The electrical resistance of a 1 m long and 10 mm wide Al foil strip having a thickness of 12 μm is about 0.22 Ohm and is thus comparable with the afore-mentioned copper foil having a material thickness of 8 μm.

Is such a 12 μm thick aluminum foil coated on both sides with a 2 μm copper layer which has the same chemical stability, such as a compact copper foil, a mass per unit area of 3.60 mg/cm² is obtained. By the copper layer the tensile strength of the foil is not negatively influenced and such a material can, thus, be processed as anode for Li-ion cells. Due to the copper layer the conductivity of the foil is improved. The electrical resistance of a 1 m long and 10 mm wide afore-mentioned Cu coated foil strip is about 0.21 Ohm.

The specific mass per unit area of the inventive multilayer foil in the described embodiment is reduced from 7.14 mg/cm² to 3.60 mg/cm². This corresponds to a weight reduction of the anode conductor foil of 50%.

For a commercially available 4Ah-lithium ion cell, the weight proportion of the copper foil containing electrical conductor of the anode is 20% of the total mass of the cell. If the 8 μm thick copper foil is replaced with the inventive multilayer foil of a 12 μm aluminum foil as substrate and a 0.2 μm thick copper layer on both sides of the foil, the mass of the cell decreases by 10% at the same energy content and unchanged performance. On the other side in a battery of equal mass about 11% more energy can be stored and also 11% more power can be gathered.

1. Use of a foil (F) as electrical conductor in an electrochemical cell (Z), characterized in that the foil (F) comprises a substrate (T) which is coated with an electrical conductor (L) and the substrate (T) has a lower specific density (mg/cm³) than the conductor (L).

2. The use according to claim 1, characterized in that
(a) the ratio of layer thickness [(L)/(T) in gm] between conductor (L) and substrate (T) is from 0.05/12.00 to 1.00/12.00,
and/or
(b) the mass per unit area of the foil (F) is not more than 7.0 mg/cm², and/or
(c) the thickness of the foil (F) is not more than 15.0 μm.

3. The use according to claim 1 or 2, characterized in that the substrate (T) has
(a) a mass per unit area of not more than 4.5 mg/cm²,
and/or
(b) a thickness of not more than 14.0 μm.

4. The use according to any one of the preceding claims, characterized in that the conductor (L) has
(a) a mass per unit area in the range from 0.5 to 6.0 mg/cm²,
and/or
(b) a thickness of not more than 0.5 μm.

5. The use according to any one of the preceding claims, characterized in that
(a) the electrochemical cell (Z) is a lithium ion cell
and/or
(b) the foil (F) is used as anode conductor.

6. The use according to any one of the preceding claims, characterized in that the substrate of the foil (F) is a polymer (P) or a metal (M).

7. The use according to claim 6, characterized in that
(a) the polymer (P) is selected from the group of thermoplastics
and/or
(b) the metal (M) is selected from the group of light metals.

8. The use according to any one of the preceding claims, characterized in that
(a) the electrochemical cell (Z) is a lithium ion cell and the conductor (L) does not form an alloy with lithium,
and/or
(b) the conductor (L) is selected from the group consisting of Ti, Zr, V, Nb, Ta, Cr, Mo, W, Mn, Fe, Co, Ni, Cu and Ag.

9. Electrochemical cell (Z) comprising a cathode conductor and an anode conductor, characterized in that either the cathode conductor or the anode conductor comprises a foil according to any one of claims 1 to 8.

10. Electrochemical cell (Z) according to claim 9, characterized in that the electrochemical cell is a lithium ion cell.
